(19) United States
(12) Patent Application Publication
(10) Pub. No.: US 2007/0087684 A1
(43) Pub. Date: Apr. 19, 2007

(54) Method and apparatus for displaying receptibility of broadcasting service

(75) Inventors: Jeong-hoon Park, Seoul (KR); Ga-hyun Ryu, Suwon-si (KR); Sun-hee Youm, Suwon-si (KR); Sung-il Park, Suwon-si (KR); Ju-hee Seo, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/529,407

(22) Filed: Sep. 29, 2006

(30) Foreign Application Priority Data
Oct. 18, 2005 (KR) 10-2005-0098227

(51) Int. Cl. H04H 1/00

(52) U.S. Cl. 455/3.01

(57) ABSTRACT

Provided are a method and apparatus for displaying the receptibility of a plurality of broadcasting services included in a single broadcasting channel as well as the receptibility of a digital broadcasting signal of a broadcasting channel. The method includes: receiving a plurality of broadcasting service bit streams included in a received broadcasting signal; checking a valid bit stream in the plurality of broadcasting service bit streams; and configuring a screen for displaying a service receptibility using the valid bit stream.

### CROSS-REFERENCE TO RELATED PATENT APPLICATION

This application claims priority from Korean Patent Application No. 10-2005-0098227, filed on Oct. 18, 2005, in the Korean Intellectual Property Office, the disclosure of which is incorporated herein in its entirety by reference.

### BACKGROUND OF THE INVENTION

1. Field of the Invention

Apparatuses and methods consistent with the present invention relate to displaying the receptibility of a digital broadcasting service, and more particularly, to displaying the receptibility of a plurality of broadcasting services included in a single broadcasting channel as well as the receptibility of a digital broadcasting signal of a broadcasting channel.

2. Description of the Related Art

Digital audio broadcasting (DAB) provides various additional data services such as transmissions of weather forecasts, traffic reports, games, and images, as well as high-quality audio services having compact disc (CD)-like quality, using new audio coding methods having a high compression rate. Specially, EUREKA-147 DAB used in Europe provides high-quality audio services having compact disc-like quality and various additional data services, using a high-quality audio compression technology based on a moving picture experts group (MPEG) audio layer II. Digital multimedia broadcasting (DMB) is a digital broadcasting form further advanced than DAB. DMB includes all of audio broadcasting, video broadcasting, and data broadcasting, and is classified into terrestrial DMB and satellite DMB. Audio broadcasting in DMB is based on DAB standards such as EUREKA-147.

When a broadcasting receiver, such as a digital multimedia receiving terminal providing digital broadcasting services, displays the receptibility of a broadcasting channel, such as the reception sensitivity, a user is informed only about the receptibility of an entire ensemble. However, a plurality of services may be provided through one channel, and the user may select a desired program service or a data service. In this regard, there is a need to provide the user with the receptibility of each service. In addition, when the service includes error correction data, the error is corrected before the service is provided to the user. Accordingly, there is a need to inform the user of the receptibility of the data service being used by the user.

### SUMMARY OF THE INVENTION

An aspect of the present invention provides a method and apparatus for displaying the receptibility of a plurality of broadcasting services included in a single broadcasting channel as well as the receptibility of a digital broadcasting signal of a broadcasting channel.

An aspect of the present invention also provides a method and apparatus for displaying the receptibility of a plurality of service components included in a plurality of broadcasting services.

An aspect of the present invention also provides a method and apparatus for displaying a receptibility of a service provided to a user, by using a bit stream in which an error is corrected, when a plurality of broadcasting services include error correction data.

According to an aspect of the present invention, there is provided a method of displaying a service receptibility, comprising: receiving a plurality of broadcasting service bit streams included in a received broadcasting signal; checking a valid bit stream in the plurality of broadcasting service bit streams; and configuring a screen for displaying the service receptibility using the valid bit stream.

The checking of the valid bit stream may comprise: detecting an error in the received broadcasting service bit streams; and calculating a bit error rate of a broadcasting service bit stream in which an error is detected.

The detecting of the error may comprise determining whether a cyclic redundancy check (CRC) packet or a forward error correction (FEC) packet included in the received broadcasting service bit streams has a valid value.

The checking of the valid bit stream may comprise: detecting an error in the received broadcasting service bit streams; when the received broadcasting service bit streams include error correction data, correcting the error in the broadcasting service bit streams using the error correction data; and calculating a bit error rate of a broadcasting service bit stream which is error-corrected. The error correction data may be generated by a Reed-Solomon coding method.

The configuring of the screen may comprise: configuring the screen for displaying a reception sensitivity using the bit error rate; and outputting the configured screen for displaying a reception sensitivity.

The checking of the valid bit stream may comprise checking the valid bit stream in a primary service component included in the broadcasting service.

The checking of the valid bit stream may comprise, when the broadcasting service includes a primary service component and a plurality of secondary service components, checking the valid bit stream in each of the primary service component and the secondary service component included in the broadcasting service.

According to another aspect of the present invention, there is provided an apparatus for displaying a service receptibility, comprising: a bit stream receiving unit which receives a plurality of broadcasting service bit streams included in a received broadcasting signal; an error calculating unit which checks a valid bit stream in the plurality of broadcasting service bit streams; and a receptibility screen configuring unit which configures a screen for displaying the service receptibility using the valid bit stream.

According to another aspect of the present invention, there is provided a broadcasting receiver comprising: a broadcasting signal processing unit which receives one of a plurality of digital broadcasting signals and outputs a plurality of broadcasting service bit streams included in the broadcasting signal; a control unit which checks a valid bit stream in the plurality of broadcasting service bit streams and configures a screen for displaying a service receptibility using the valid bit stream; and an outputting unit which outputs the configured screen for displaying a service receptibility.

According to another aspect of the present invention, there is provided a computer-readable medium having embodied thereon a computer program for executing the above-described method of displaying a service receptibility.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a configuration of a broadcasting receiver for displaying receptibility of a broadcasting service according to an exemplary embodiment of the present invention;

FIG. 2 is a block diagram illustrating a configuration of a control unit included in the broadcasting receiver illustrated in FIG. 1;

FIG. 3 illustrates a multi-structure of a digital multimedia broadcasting (DMB) service according to an exemplary embodiment of the present invention;

FIG. 4 illustrates a structure of a DMB transfer frame according to an exemplary embodiment of the present invention;

FIG. 5 illustrates a configuration of FIG 0/2 according to an exemplary embodiment of the present invention;

FIG. 6 is a flowchart of a method of displaying receptibility of a broadcasting service according to an exemplary embodiment of the present invention;

FIG. 7 is a flowchart of a method of displaying receptibility of a broadcasting service according to another exemplary embodiment of the present invention;

FIG. 8 illustrates a screen for displaying receptibility of a broadcasting service according to an exemplary embodiment of the present invention; and

FIG. 9 illustrates a screen for displaying receptibility of a broadcasting service according to another exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

In the present specification, receptibility is defined as a ratio of a valid bit stream to the received broadcasting stream, and includes information on a receptibility degree of accurate data in which an error is not generated, and a receptibility degree of a bit stream in which an error is corrected using error correction data and which is actually provided to a user when the broadcasting stream includes the error correction data such as a Reed-Solomon coding data and the error generated in the data can be corrected.

FIG. 1 is a block diagram illustrating a configuration of a broadcasting receiver for displaying receptibility of a broadcasting service according to an embodiment of the present invention.

The broadcasting receiver according to the present embodiment includes a broadcasting signal processing unit 110, a control unit 120, and an output unit 130.

The broadcasting signal processing unit 110 includes an antenna 11 1, a tuner 1 13, a channel decoder 1 15, a demultiplexer 1 17, and a decoder 119, and receives one of a plurality of digital broadcasting signals and outputs a plurality of broadcasting service bit streams included in the broadcasting signal.

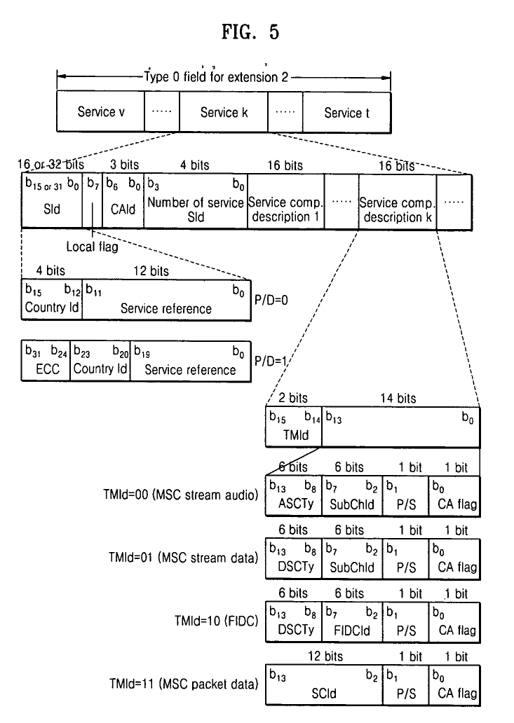

In the broadcasting signal processing unit 110, the tuner 113 tunes one of a plurality of channels and outputs one of the plurality of digital broadcasting signals received from the antenna 111. The channel decoder 115 performs channel decoding by a predetermined method, parses a fast information channel (FIC), and generates a service list, thereby displaying the service list to a user. FIC data includes a service encoding parameter and packetizing information. Thus, when the FIC is analyzed, it can be determined what service is provided and how the data configuring the service is encoded and packetized. Particularly, when the information of FIG 0/2, which will be described with reference to FIG. 5, is analyzed, the configuration information of the service can be checked.

When a user selects a service, the demultiplexer 117 extracts and outputs service data corresponding to the service. When the user selects a video service, an encoded video stream, an encoded audio stream, and an encoded additional data stream, which configure the video service, are delivered to the decoder 119 and decoded by the decoder 119. The decoder 119 provides the decoded signal to the output unit 130. The decoder 119 may include a plurality of video decoders, audio decoders, and data decoders.

The control unit 120 controls each unit in accordance with the analyzed FIC information. Furthermore, when receiving the bit stream of each of the plurality of broadcasting services included in a received digital multimedia broadcasting signal, the control unit 120 checks a valid bit stream in the plurality of broadcasting service bit streams and configures a screen for displaying receptibility of the service using the checked valid bit stream.

The output unit 130 outputs the signal output from the decoder 119 and the screen configured by the control unit 120 to display the receptibility of the service.

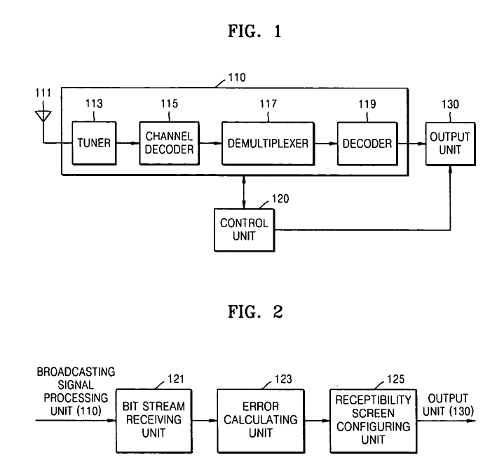

FIG. 2 is a block diagram illustrating a configuration of the control unit 120 included in the broadcasting receiver of FIG. 1.

The control unit 120 according to the present embodiment includes a bit stream receiving unit 121, an error calculating unit 123, and a receptibility screen configuring unit 125.

The bit stream receiving unit 121 receives the plurality of broadcasting service bit streams included in the broadcasting signal received from the broadcasting signal processing unit 110. The bit stream receiving unit 121 may receive the bit stream of the ensemble from the channel decoder 115 of FIG. 1, and the bit stream of the service from the demultiplexer 117.

The error calculating unit 123 checks the valid bit stream in the plurality of broadcasting service bit streams received from the bit stream receiving unit 120. The error calculating unit 123 can check a valid bit stream rate by a method of detecting the error in the received broadcasting service bit streams and calculating a bit error rate of the broadcasting service bit streams having the detected error. For example, if the bit error rate is 0.5, the valid bit stream rate may be 0.5 (1−0.5=0.5). Furthermore, in order to display the receptibility of the ensemble, the error calculating unit 123 calculates a signal-to-noise ratio (SNR) of the bit stream of the ensemble output from the channel decoder 115 to check the receptibility of the ensemble.

When the broadcasting service includes a primary service component and a secondary service component, the error calculating unit 123 may check only the valid bit stream in the primary service component to check receptibility of the primary service component. Alternatively, the error calculating unit 123 may check the valid bit streams in the primary service component and at least one secondary service component to check the receptibility of the service components included in the service.

The error calculating unit 123 may determine whether a cyclic redundancy check (CRC) packet or a forward error correction (FEC) packet inserted for detecting the error in the received broadcasting service bit streams has a valid value to detect the error. That is, the error calculating unit 123 can calculate the bit error rate by calculating a ratio of bit streams including a valid CRC or FEC packet among a predetermined number of received bit streams. As such, the method of using the CRC packet is mainly used for displaying the receptablities of the audio service and the data service.

In addition, when receiving the received broadcasting service bit streams including the data having the error which can be corrected by a Reed-Solomon coding method, such as the video service, the error calculating unit 123 may correct the error in the broadcasting service bit streams having the detected error using the error correction data and calculate the bit error rate of the broadcasting service bit streams in which the error is corrected. Here, the error correction data may be generated by the Reed-Solomon coding method. Since the data generated by the Reed-Solomon coding method has a predetermined range of error correcting capability, a bit stream having the error which is out of the predetermined range is determined to be an invalid bit stream. Accordingly, among the received bit streams, the bit stream in which the error is not generated or is corrected is determined to be the valid bit stream to calculate the bit error rate. As such, the method of using the Reed-Solomon coding method is mainly used for displaying the receptibility of the video service.

According to this method, when the error can be corrected, the receptibility of the service can be provided to the user in consideration of the receptibility of the data in which the error is corrected as well as the receptibility of the actually received data, and thus the user can determine the accuracy of the provided service.

The receptibility configuring unit 125 configures the screen for displaying the receptibility of the service using the checked valid bit stream. At this time, the screen is configured using the bit error rate checked by the error calculating unit 123 and the configured screen is output.

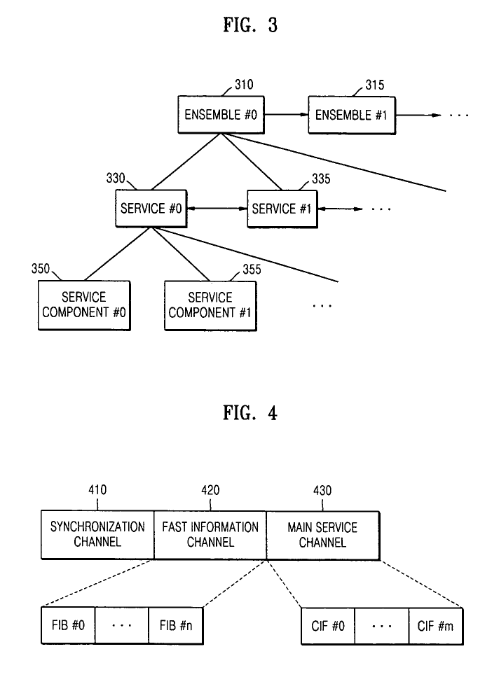

FIG. 3 illustrates a multi-structure of a digital multimedia broadcasting (DMB) service according to an embodiment of the present invention.

Referring to FIG. 3, the multi-structure of the DMB service has ensembles, services, and service components.

The ensemble indicates one bit stream obtained by respectively channel-coding a plurality of encoded audio streams and a plurality of data and multiplexing the plurality of encoded audio streams and the plurality of data together with system data. Generally, one broadcasting station provides one ensemble. The service indicates an output selected by the user, such as the program service or the data service, and the service component indicates the component configuring the service. The service components of a given service are connected to each other by multiplex configuration information (MCI). The service components are carried on a sub channel or a fast information data channel and then transmitted.

The DMB service according to the present embodiment includes at least two ensembles including an ensemble #0 310 and an ensemble #1 315. The ensemble #0 310 provides at least two services including a service #0 330 and a service #1 335. The service #0 330 includes at least two service components including a service component #0 350 and a service component #1 355.

FIG. 4 illustrates a structure of a DMB transfer frame according to an embodiment of the present invention.

The DMB transfer frame includes a synchronization channel (SC) 410, a fast information channel (FIC) 420, and a main service channel (MSC) 430.

The synchronization channel 410 includes a null symbol which can determine a transmission mode and a reference symbol necessary for OFDM symbol synchronization and carrier frequency synchronization.

The FIC 420 is used for transmitting information required when a receiving device processes data, for example, information on a service configuration and a multiplexed form or transmitting data which need to be fast transmitted. The FIC 420 includes multiplex configuration information (MIC) containing information on the structure of each sub channel, and service information (SI), which is additional information of each service. Accordingly, by checking the FIC 420, it is checked what service data is transmitted through the MSC 430 and the application that uses the service. Furthermore, the FIC 420 includes a fast information data channel (FIDC) including data which must be fast transmitted in a predetermined time. The FIDC contains, for example, a short message on an emergency. The FIC 420 includes a plurality of blocks such as fast information blocks (FIB). Each FIB includes a FIB data field and a CRC field. The FIB data field includes FIGs. In each FIG, a FIG type field which indicates the form of the data contained in a FIG data field and a length field which indicates the length of the FIG data field are inserted into a header unit and actual data is contained in the FIG data field.

The main service channel MSC 430 transmits actual content data provided by a service provider. When the space of the FIC 420 is insufficient, the MSC 430 may contain a portion of the FIC data. However, the MSC 430 cannot contain the FIC data which must be fast transmitted, since it takes much time to apply time interleaving and perform decoding. A data transmitting mode includes a stream mode or a packet mode. The MSC 430 includes a plurality of frames such as common interleaved frames (CIF).

FIG. 5 illustrates a configuration of FIG 0/2 according to an embodiment of the present invention.

The FIG 0/2 (type 0 field for extension 2) contains information on a service configuration. Service description applied to a single service is contained in a single field (service field k).

In these fields, if a transport mechanism identifier (TMId) is “00”, the service component represents a stream mode audio service, if the TMId is “01”, the service component represents a stream mode data service, if the TMId is “10”, the service component represents a fast information data channel service, and, if the TMId is “11”, the service component represents a packet mode data service. A data service component type (DSCTy) represents the type of the data service component.

In the present embodiment, when the Reed-Solomon coding method for correcting the error is used in the stream mode for the video service, it is possible to record in the DSCTy field that an error reinforcement method which can detect and correct an error is used.

When the service includes a primary service component and at least one secondary service component, it can be determined by a primary/secondary (P/S) field of service component description whether the service component is the primary component or the secondary component. If the value of the P/S field is “0”, the service component represents the secondary service, and, if the value of the P/S field is “1”, the service component represents the primary service.

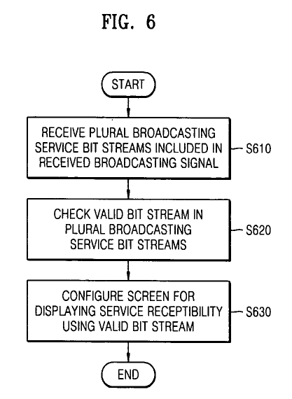

FIG. 6 is a flowchart of a method of displaying receptibility of a broadcasting service according to an embodiment of the present invention.

A plurality of broadcasting service bit streams included in a received broadcasting signal are received (S610). A valid bit stream in the plurality of broadcasting service bit streams is checked (S620). The valid bit stream can be checked by a method of detecting the error in the broadcasting service bit streams and calculating a bit error rate of the broadcasting service bit streams having the detected error. When the received broadcasting service bit streams include error correction data, the valid bit stream can be checked by a method of correcting the error in the broadcasting service bit streams having the detected error using the error correction data and calculating a bit error rate of the broadcasting service bit streams in which the error is corrected.

A screen for displaying the receptibility of the broadcasting service is configured using the checked valid bit stream (S630).

In order to check the valid bit stream in the broadcasting service bit streams, the above-described process on specific bit streams is performed. Thus, since the reception environment changes in the process of receiving the bit stream, the receptibility of the received bit streams can be changed and displayed in accordance with the reception environment.

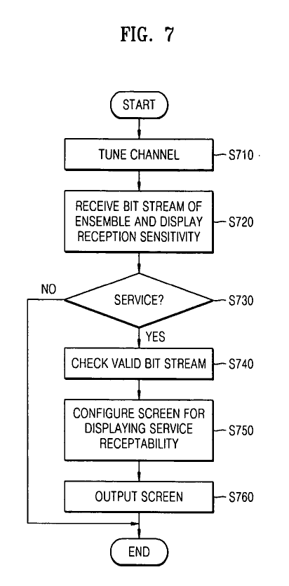

FIG. 7 is a flowchart of a method of displaying receptibility of a broadcasting service according to another embodiment of the present invention.

A channel is tuned (S710), and a bit stream of the ensemble included in a received broadcasting signal is received and a receptibility thereof is displayed (S720). The receptibility of the bit stream of the ensemble is checked by a method of calculating the SNR and a screen for displaying the receptibility is configured. When a plurality of service bit streams included in the ensemble are received (S730), a valid bit stream in the plurality of broadcasting service bit streams is checked (S740).

A screen for displaying the service receptibility is configured using the checked valid bit stream (S750) and is then output (S760).

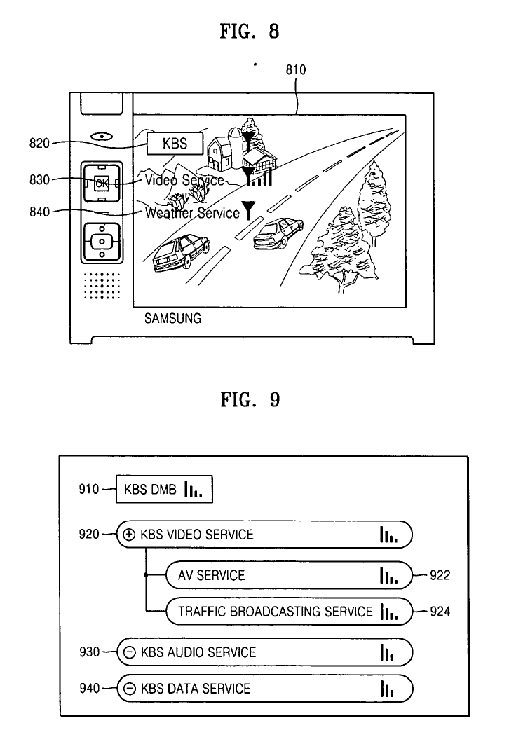

FIG. 8 illustrates a screen for displaying receptibility of a broadcasting service according to an embodiment of the present invention.

A receptibility 820 of the ensemble and receptabilities 830 and 840 of the service are overlapped and displayed on a service screen 810. In FIG. 8, of a primary service component and a secondary service component included in the broadcasting service, only the receptibility of the primary service component is displayed. Furthermore, the receptibility of the service may be displayed using various methods other than that illustrated in FIG. 8.

Generally, since the video service includes error correction data, the receptibility is displayed using the bit stream in which the error is corrected. Accordingly, as illustrated in FIG. 8, the receptibility 830 of the video service can be displayed differently from the receptibility 820 of the ensemble and the receptibility 840 of the data service such as a weather service.

FIG. 9 illustrates a screen for displaying receptibility of a broadcasting service according to another embodiment of the present invention.

In this case, receptibility 910 of the ensemble, receptibilities 920, 930, and 940 of the services, and receptibilities 922 and 924 of the service components are displayed on the screen. When the broadcasting service includes a primary service and at least one secondary service, if a user clicks a receptibility item of the broadcasting service, for example, KBS video service item 920, the receptibilities of the service components included in the broadcasting service, for example, the receptibility 922 of an AV service and the receptibility 924 of a traffic broadcasting service may be provided.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

As described above, according to an aspect of the present invention, there are provided a method and apparatus for displaying the receptibility of a plurality of broadcasting services included in a single broadcasting channel as well as the receptibility of a digital broadcasting signal of a broadcasting channel.

According to an aspect of the present invention, there are provided a method and apparatus for displaying receptibility of a plurality of service components included in a plurality of broadcasting services.

According to an aspect of the present invention, it is possible to display receptibility of a digital broadcasting signal as a ratio of bit streams, in which an error is not generated or is corrected, to received bit streams using a bit stream in which error is corrected, when a plurality of broadcasting services include error correction data.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of displaying a service receptibility, comprising:
receiving a plurality of broadcasting service bit streams included in a received broadcasting signal;
checking a valid bit stream in the plurality of broadcasting service bit streams; and
configuring a screen for displaying the service receptibility using the valid bit stream.

2. The method of claim 1, wherein the checking of the valid bit stream comprises:
detecting an error in the received broadcasting service bit streams; and
calculating a bit error rate of a broadcasting service bit stream in which an error is detected.

3. The method of claim 2, wherein the detecting of the error comprises determining whether a cyclic redundancy check (CRC) packet or a forward error correction (FEC) packet included in the received broadcasting service bit streams has a valid value.

4. The method of claim 1, wherein the checking of the valid bit stream comprises:
detecting an error in the received broadcasting service bit streams;
when the received broadcasting service bit streams include error correction data, correcting the error in the broadcasting service bit streams using the error correction data; and
calculating a bit error rate of a broadcasting service bit stream which is error-corrected.

5. The method of claim 4, wherein the error correction data is generated by a Reed-Solomon coding method.

6. The method of claim 2, wherein the configuring of the screen comprises:
configuring the screen for displaying a reception sensitivity using the bit error rate; and
outputting the configured screen for displaying a reception sensitivity.

7. The method of claim 1, wherein the checking of the valid bit stream comprises checking the valid bit stream in a primary service component included in the broadcasting service.

8. The method of claim 1, wherein the checking of the valid bit stream comprises:
when the broadcasting service includes a primary service component and a plurality of secondary service components, checking the valid bit stream in each of the primary service component and the secondary service components included in the broadcasting service.

9. An apparatus for displaying a service receptibility, comprising:
a bit stream receiving unit which receives a plurality of broadcasting service bit streams included in a received broadcasting signal;
an error calculating unit which checks a valid bit stream in the plurality of broadcasting service bit streams; and
a receptibility screen configuring unit which configures a screen for displaying the service receptibility using the valid bit stream.

10. The apparatus of claim 9, wherein the error calculating unit detects an error in the received broadcasting service bit streams and calculates a bit error rate of the broadcasting service bit streams.

11. The apparatus of claim 10, wherein the error calculating unit determines whether a cyclic redundancy check (CRC) packet or a forward error correction (FEC) packet included in the received broadcasting service bit streams has a valid value, when detecting the error.

12. The apparatus of claim 9, wherein, when checking the valid bit stream, the error calculating unit detects an error in the received broadcasting service bit streams, corrects an error in an error-detected broadcasting service bit stream using error correction data when the received broadcasting service bit streams include the error correction data, and calculates a bit error rate of the error-corrected broadcasting service bit stream.

13. The apparatus of claim 12, wherein the error correction data is generated by a Reed-Solomon coding method.

14. The apparatus of claim 10, wherein the receptibility screen configuring unit configures the screen for displaying a reception sensitivity using the bit error rate, and outputs the configured screen for displaying a reception sensitivity.

15. The apparatus of claim 9, wherein the error calculating unit checks the valid bit stream in a primary service component included in the broadcasting service.

16. The apparatus of claim 9, wherein, when the broadcasting service includes a primary service component and a plurality of secondary service components, the error calculating unit checks the valid bit stream in each of the primary service component and the secondary service components included in the broadcasting service.

17. A broadcasting receiver comprising:
a broadcasting signal processing unit which receives one of a plurality of digital broadcasting signals and outputs a plurality of broadcasting service bit streams included in the broadcasting signal;
a control unit which checks a valid bit stream in the plurality of broadcasting service bit streams and configures a screen for displaying a service receptibility using the valid bit stream; and
an outputting unit which outputs the configured screen for displaying a service receptibility.

18. A computer-readable medium having embodied thereon a computer program for executing the method of claim 1.

19. A computer-readable medium having embodied thereon a computer program for executing the method of claim 2.

20. A computer-readable medium having embodied thereon a computer program for executing the method of claim 3.
